(19) United States
(12) Patent Application Publication
(10) Pub. No.: US 2023/0407104 A1
(43) Pub. Date: Dec. 21, 2023

(54) COMPOSITIONS AND METHODS FOR DETECTION OF A MATERIAL OF INTEREST

(71) Applicant: TIAX LLC, Lexington, MA (US)

(72) Inventor: Kevin Beltis, Natick, MA (US)

(21) Appl. No.: 18/242,309

(22) Filed: Sep. 5, 2023

Related U.S. Application Data
(63) Continuation of application No. 16/037,260, filed on Jul. 17, 2018.
(60) Provisional application No. 62/533,160, filed on Jul. 17, 2017.

(51) Int. Cl. C09D 5/02; C09D 129/04; B05D 3/10; A62D 3/30; A62D 5/00; A62D 3/02

(52) U.S. Cl. CPC C09D 5/025; C09D 5/022; C09D 129/04; B05D 3/108; A62D 3/30; A62D 5/00; A62D 3/02; C08K 2003/387

(57) ABSTRACT

Provided are processes and compositions for capturing a material of interest such as a biological, chemical, or other toxic agent on or from a surface. A method includes applying a liquid polymeric coating to a surface having a material of interest deposited thereon, encapsulating the material of interest with the composition, curing or otherwise solidifying the composition to form a polymeric coating on the surface, and optionally peeling the coating from the surface. The peeling may remove a portion or all of the material of interest from the surface. Also provided are devices that may be used in the processes provided herein.

### CROSS REFERENCE TO RELATED APPLICATIONS

This application is a continuation of U.S. patent application Ser. No. 16/037,260 filed Jul. 17, 2018, and which depends from and claims priority to U.S. Provisional Application No. 62/533,160 filed Jul. 17, 2017, the entire contents of which are incorporated herein by reference.

### STATEMENT OF GOVERNMENT INTEREST

Funding for the present invention was obtained from the Government of the United States by virtue of Contract Nos. F33615-03-M-6381 from the US Air Force and EP-D-06-059 and EP-D-17-013 from the U.S. Environmental Protection Agency (EPA). Thus, the Government of the United States has certain rights in and to the invention claimed herein.

### TECHNICAL FIELD

The present specification generally relates to methods and compositions for neutralization of materials and, more specifically, methods and compositions for neutralization of materials that enable safe decontamination and disposal of the materials.

### BACKGROUND

The possible use of chemical and/or biological warfare agents and/or radiological (i.e. particulate) (CBR) contamination during a military action or terrorist attack presents a continuous threat to U.S. military and civilian personnel. The advances in the biotechnology area and the resulting ease of preparing significant quantities of infectious agents and biological toxins have further increased the threat of dissemination of biological hazards as well as the ongoing potential for other weapons of mass destruction such as chemical and radiological threats.

Anthrax has been identified as one of the most probable biological warfare agent terrorist threats. Typically, anthrax would be disseminated as an aerosol in a terrorist attack. The mortality rate of exposed, untreated individuals is greater than 90% and would be expected to act in 1 to 7 days, with most deaths occurring within 48 hours. Anthrax spores are extremely hardy and can persist in the environment for more than 50 years. Many biological warfare agent decontaminants are not effective against anthrax spores. Moreover, any remaining anthrax spores can present an ongoing threat to individuals, including those assisting with decontamination efforts.

Detecting these and other materials of interest is paramount to effectively combat such threats. Accordingly, there is a need for nonhazardous methods and compositions that are effective in encapsulating a chemical and biological material of interest and being able to then analyze the composition for the presence or absence of such material of interest.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

Provided are methods of collecting a material of interest for detection that include: contacting a liquid polymeric coating to a substrate surface or gas, the substrate or gas comprising the material of interest, the polymeric coating comprising a polymer or polymerizable resin; encapsulating the material of interest with the polymeric coating; curing the liquid polymeric coating to form a sampling device, and peeling the sampling device from the surface so as to remove the material of interest from the surface. While any material of interest may be collected, in some aspects, a material of interest is a biological agent (e.g. a bacteria, a bacterial spore, a protein, or a virus), a chemical nerve agent, a chemical blister agent, a radiological agent, a blood agent, a lung damaging agent, a toxic industrial chemical (TIC), a toxic industrial material (TIM), any other agent used in a weapon of mass destruction, or any combination thereof. In some aspects, a polymeric coating may further include a pH modifier, pigment, suspension aid, rheology modifier, solid sorbent, ion exchange resin, or combination thereof. The surface may be a painted surface, a plastic surface, or a glass surface. The polymeric coating may be cured onto said surface within a time of 2 hours or less at room temperature. The device may further be peeled from said surface in a single piece, or in several large pieces, without flaking. In some aspects, the polymeric coating is applied to said substrate using a sheet material, optionally wherein the polymeric coating is present on one side of the sheet material. The sheet material may in some aspects be formed from one or more polymers selected from the group consisting of polycarbonate, polyvinylidene fluoride (PVdF), polystyrene, acrylic, nylon, polyethylene, polypropylene, polyvinyl chloride, and combinations thereof. The method optionally further includes comprising rolling or folding said sampling device upon itself to seal the material of interest inside a folded sampling device following said peeling. In some aspects, the method further includes dissolving the sampling device or a portion thereof in an organic or aqueous solvent to form a dissolved sampling device. Optionally, a method further includes extracting said material of interest from sampling device by applying filtration, recovery, or other extraction technique to said dissolved sampling device. Optionally, the method further includes analyzing the sampling device by one or more chromatographic techniques, spectroscopic techniques, or other analytical chemistry technique. Optionally, the analytical chemistry technique is one or more of gas chromatography, liquid chromatography, mass spectrometry, x-ray diffraction, atomic absorption, scanning electron microscopy, DNA assay, and direct spore counting.

Also provided are devices that may be configured for collecting a material of interest from a surface. A devices optionally includes a sheet material; a liquid polymeric coating contacting at least a portion of the sheet material, the polymeric coating comprising a polymer or polymerizable resin; optionally wherein the polymeric coating is curable as a film on or in the sheet material so as to form a sampling device configured to adhere to a surface so as to be peeled from the surface in a single piece, or in several large pieces, without flaking. The device optionally further includes a removable protective strip applied to said polymeric coating. Optionally, the sheet material is formed from one or more selected from the group consisting of polycarbonate, polyvinylidene fluoride (PVdF), polystyrene, acrylic, nylon, polyethylene, polypropylene, polyvinyl chloride, and combinations thereof. In some aspects, the device optionally further includes a packaging material configured to encapsulate the sampling device. The packaging material is optionally formed from a biaxially-oriented polyethylene terephthalate. The sampling device optionally includes with the polymeric coating one or more of a pigment, a suspension aid, or a rheology modifier.

These and additional features provided by the present disclosure will be more fully understood in view of the following detailed description in conjunction with the drawings, abstract, and claims provided.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a peelable polymeric film formed from a composition being removed from a contaminated surface according to one or more embodiments shown and described herein; and

FIG. 2 depicts a polymerized composition and an exemplary use as a sampling device according to one or more embodiments shown and described herein.

### DETAILED DESCRIPTION

The following description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Provided are compositions that include a polymer or polymerizable resin. When the composition is applied to a surface including a material of interest, such as a biological agent, the composition encapsulates or otherwise adheres to the material of interest and then is cured. Curing of the composition forms a polymeric coating on the surface, and the material of interest is contained within or is adhered to the polymeric coating. In various embodiments, the polymeric coating can be peeled from the surface, optionally in a single piece, thereby removing the material of interest from the surface or reducing the amount of material that remains on the surface. Various embodiments of the composition and methods of using the composition will be described in more detail herein.

As used herein the term “neutralization” or “neutralize” are defined as causing a material of interest to be less capable of causing damage to an organism or present in a reduced amount on a previously contaminated surface so as to be less able to cause damage to an organism. The term “totally neutralize” or “total neutralization” are intended to mean that the material of interest is substantially undetectable on a previously contaminated surface or the material of interest is non-viable following a process as described herein or treatment with a composition as provided herein.

As used herein the term “resin” describes a solid or liquid organic monomer or polymer, optionally a polymerizable synthetic solid or liquid organic monomer or polymer. A resin may be an aqueous resin that is includes water or water soluble material as a solvent, or is an organic solvent resin that includes one or more non-aqueous organic solvents that are substantially insoluble in water.

Provided herein are compositions that are capable of encapsulating or bonding to a material of interest, optionally a material of interest that includes or is a biological agent. A composition includes at least a polymer or polymerizable resin. As will be described in greater detail below, the composition may further include one or more pH modifiers, pigments, suspension aids, rheology modifiers, solid sorbents, ion exchange resins, or reactive metal oxides. Additional or alternative additives may also be included, depending on the particular embodiment.

A resin optionally is or includes one or more polyurethanes, polyethylene terephalate (PET), silicones, natural or synthetic rubbers, or other materials. A resin is optionally a cross-linkable polymer resin, optionally the like of an unsaturated polyester resin or vinyl ester resin. The prepolymer resin optionally has a molecular weight at or between 400 and 10,000 Daltons.

A polyester prepolymer is optionally the result of a condensation reaction between unsaturated dibasic acids and/or anhydrides with one or more polyols. Vinyl ester resins are optionally the reaction product of an epoxy resin with a carboxylic acid having a single ethylenic unsaturation. Vinyl ester resins prepolymers are typically associated with terminal ethylenic unsaturations while polyester resin prepolymers typically include ethylenic unsaturations internal to the prepolymer backbone.

In particular embodiments, a resin is optionally vinyl ester resin (vinyl resin), optionally a water-soluble vinyl resin. The vinyl resin may be in the form of an emulsion including vinyl resin in water. Illustrative examples of a vinyl resin include alkyl polymers characterized by a vinyl group. Specific examples include polymers of styrene, isoprene, other vinyl alkenes, or derivatives thereof, among others. In some embodiments, the emulsion including the vinyl resin may have a boiling point of greater than about 100° C., and may include from about 20 wt % to about 60 wt % solids based on the total weight of the solution. In some particular embodiments, the emulsion includes from about 20 wt % to about 40 wt % solids, optionally 25 wt % to about 30 wt % solids, or even about 27 wt % solids. The emulsion may be made by emulsifying a vinyl resin in water. Alternatively, the vinyl resin may be a commercially available vinyl resin emulsion, or may include generic formulations of latex with or without other polymers illustratively styrene-butadiene rubber (SBR). Optionally a vinyl resin may be a polyvinyl alcohol (PVA) emulsion in water. Suitable commercially available vinyl resin emulsions include, but are not limited to, those available under the tradename FLOORPEEL™, including FLOORPEEL™ 4000, available from General Chemical Corporation (Brighton, MI), Vinnol E15/45 VL (Wacker Chemical Corporation, UCAR 451 IC (Arkema, Inc.), and STRIPCOAT TLC FREE™, available from BHI Energy (Weymouth, MA). Optionally, the emulsion forms a solid, strippable polymeric coating upon setting (e.g., curing or drying), as will be described in greater detail below.

Although embodiments described herein include a vinyl resin, it is contemplated that any other film-forming polymer or elastomer capable of forming a solid, strippable coating upon setting may be used in addition to or in place of the vinyl resin. For example, an elastomeric silicone (e.g. polysiloxane) may be used in the composition. In some aspects a polysiloxane peelable coating compositions is as described in JP2001089697A.

In some aspects, a composition includes one or more active decontaminants. An active decontaminant may be, for example, a biocide. In some embodiments, the active decontaminant may be, for example, a protein, enzyme or chemical that is effective to nullify one or more materials of interest, optionally biological agents, chemical nerve agents, chemical blister agents, blood agents, and/or lung damaging agents. As used herein, “nullify” means to kill, render substantially inactive, or encapsulate.

In various embodiments, an active decontaminant may be a quaternary ammonium compound or mixture, a quaternary phosphonium compound or mixture, or other biocide. Optionally, a biocide is a quaternary ammonium compound or mixture, illustratively a benzalkonium chloride (BAC) such as benzyltrimethylammonium chloride, benzyltriethylammonium chloride, or others. Optionally, a biocide is a quaternary phosphonium compound, illustratively tetrakishydroxymethyl phosphonium sulfate (THPS).

Optionally, other active decontaminant(s) may be used illustratively triclosan (2,4,4′-trichloro-2′-hydroxydiphenyl ether), streptomycin, sodium phrithione (commercially available as Sodium Omadine® from Lonza), dichlorphen, methylene bisthiocyanate, and combinations thereof. Other suitable active decontaminants may include formaldehyde donors (e.g., paraformaldehyde, N-formals, O-formals), higher aldehyde donors (e.g., glutaraldehyde, ortho-phthalaldehyde), chlorine dioxide generators, and peroxygen generators.

In some embodiments, other active decontaminants may be employed depending on the particular material of interest. Without being bound by theory, it is believed that suitable active decontaminants act according to at least one of the following three mechanisms: denaturation of proteins; sulfhydral enzyme and amino acid oxidation or alkylation; and disruption or binding of access points in the cellular wall. The biocide reaches the target and executes one or more of the mechanisms of action, thereby nullifying the material of interest. It is further believed that incorporating the active decontaminant into the polymer matrix may control the release of the active decontaminant.

Without being bound by theory, it is believed that commercially available biocides may offer a number of advantages when used as an active decontaminant as provided herein, including but not limited to, broad spectrum efficacy against several classes of bacteria, activity at ppm levels, and prior manufacturer registration for use with the FDA and/or EPA. In various embodiments, the biocide may include THPS.

In various embodiments, the active decontaminant may include a blended biocide composition, such as a blend of triclosan, BAC, and THPS. For example, the active decontaminant may include from greater than 0 wt % up to about 6.6 wt % triclosan, from greater than 0 wt % up to about 2.5 wt % BAC and from greater than 0 wt % up to about 3.0 wt % THPS based on a total weight of the active decontaminant. In some embodiments, the active decontaminant may include from about 0.1 wt % to about 1 wt % triclosan, from about 0.1 wt % to about 2.5 wt % BAC, and from about 0.1 wt % to about 3.0 wt % THPS based on a total weight of the active decontaminant. In one particular embodiment, the active decontaminant may include about 0.5 wt % triclosan, about 0.5 wt % BAC, and about 1.5 wt % THPS based on a total weight of the active decontaminant.

The active decontaminant may be present in any suitable amount. In various embodiments, the composition includes from about 1 wt % to about 15 wt % of the active decontaminant based on a total weight of the composition. For example, the composition may include from about 1 wt % to about 15 wt % of the active decontaminant, from about 1 wt % to about 14 wt % of the active decontaminant, from about 1 wt % to about 13 wt % of the active decontaminant, from about 1 wt % to about 12 wt % of the active decontaminant, from about 2 wt % to about 15 wt % of the active decontaminant, or from about 2 wt % to about 14 wt % of the active decontaminant based on a total weight of the composition. It is contemplated that in some embodiments, higher concentrations of active decontaminant may be included, such as when the composition will be diluted prior to use.

More than one active decontaminant may be present in the composition. Optionally 1, 2, 3, 4, 5, or more active decontaminants may be present. Optionally at least two decontaminants are present, optionally with differing functional activities. Optionally at least three decontaminants are present, optionally with differing functional activities.

In various embodiments, the composition may include a pH modifier to adjust a pH of the composition. Suitable pH modifiers may include, by way of example and not limitation, sodium carbonate, calcium carbonate, sodium bicarbonate, sodium tetraborate hexahydrate (i.e., Borax), sodium hydroxide, and combinations thereof. In various embodiments, the pH modifier may be added in any suitable amount to bring the pH of the composition to a pH of greater than about 6.0. For example, the pH modifier may bring the composition to a pH of from about 8.0 to about 9.0. In some particular embodiments, the composition has a pH of about 8.5. Without being bound by theory, it is believed that the pH of about 8.5 may result in the apparent concentrations of the active decontaminant, resulting in a greater efficacy of the composition.

Optionally, the composition may include one or more pigments to impart a color to, or alter a color of, the composition. For example, a pigment may be included in the composition such that when the composition forms a coating on a surface, a user can readily identify the coating on the surface and confirm removal of the coating from the surface. Any one of a variety of suitable pigments may be employed, provided they do not significantly adversely impact the efficacy of the active decontaminant. In some embodiments, the pigment may be titanium dioxide (TiO₂), iron oxide, carbon black, or any pigment that will not appreciably inhibit cure or affect neutralization. When included in the composition, the pigment may be present in an amount of from about 0 wt % to about 25 wt %, or any value or range therebetween.

The composition may further include one or more optional suspension aids. The suspension aid may enhance the stability of the particles in the composition to prevent particles from agglomerating and settling or floating out of the composition. Any suitable suspension aid may be used, such as, for example, clays, cellulosic polysaccharides, synthetic hydrocarbon polymers, biopolymer polysaccharides, acrylic copolymers, or the like. In some embodiments, kaolin clay may be used as a suspension aid. When included in the composition, the suspension aid may be present in an amount of from about 0 wt % to about 10 wt % or any value or range therebetween, optionally 0.1 wt % to 10 wt %.

In various embodiments, an optional rheology modifier is further included in the composition. A rheology modifier is a compound or compounds that act to change the viscosity of the dispersion, typically by increasing the viscosity. In some embodiments, the suspension aid may additionally function as a rheology modifier. In various embodiments, the rheology modifier is a water-based rheology modifier, such as a hydrophobically-modified ethoxylate urethane (HEUR). However, it is contemplated that other rheology modifiers may be employed, depending on the particular embodiment. In embodiments that include a rheology modifier, the composition may include from about 0 wt % to about 25 wt % of the rheology modifier, based on a total weight of the composition.

The composition may further include an optional solid sorbent. In embodiments in which a solid sorbent is included, the solid sorbent may provide greater surface area for interaction with the material of interest, and may act as a reservoir for the composition. In various embodiments, the solid sorbent is in the form of a nanocrystal or fine powder. It is contemplated that the solid sorbent may be present in other forms, although it is believed that the use of nanocrystals or fine particles may facilitate mixing into the polymer matrix and/or provide additional enhancements to the surface area. The solid sorbent may be, for example, fuller's earth, silica gel, amorphous silicates, or the like. Other solid sorbents may be employed, such as charcoal or other known solid sorbents. In embodiments that include a solid sorbent, the composition may include from about 1 wt % to about 25 wt % of the solid sorbent, based on a total weight of polymer solids in the composition.

Some embodiments of the composition may further include an optional reactive metal oxide. When included, the reactive metal oxide may be used to mitigate the toxicity of the material of interest. In various embodiments, the reactive metal oxide may be in the form of a nanocrystalline metal oxide. Without being bound by theory, it is believed that the reactive metal oxide may work with the solid sorbent, when both are included in the composition, to react with and retain the material of interest, but not degrade the polymeric substrate of the composition. For example, the material of interest may be absorbed into the polymer to form a solid solution and any toxic by-products may continue to migrate within the polymer matrix. Accordingly, the reactive metal oxide and/or the solid sorbent may react with and/or adsorb the by-product, rendering the by-product non-hazardous.

The metal oxide may be, for example, titanium dioxide, magnesium oxide, nanocrystalline lime (CaO), aluminum oxide, or the like. In some embodiments, the metal oxide may include a halogen adduct (e.g., Cl₂ or Br₂). In embodiments that include a metal oxide, the composition may include from about 0 wt % to about 10 wt % of the metal oxide, based on a total weight of polymer solids in the composition.

As an alternative to, or in addition to, a metal oxide, some embodiments may include one or more other materials to aid in the encapsulation of toxic materials that could create vapor hazards. For example, metal ion catalysts (e.g., copper (II)), enzymes for decontamination and biodegradation, catalytic oxidation agents such as N-cyclohexyl-2-pyrrolidone, solid polymer matrices, and/or ion exchange resins may be included. Ion exchange resins may be, for example, acidic cation-exchange resins or basic anion-exchange resins.

To prepare the composition, an optional active decontaminant and any additives (including, but not limited to, pH modifiers, pigments, suspension aids, rheology modifiers, solid sorbents, ion exchange resins or reactive metal oxides) may be added to the vinyl resin and mixed thoroughly. Optionally a suspension of vinyl resin is made in a solvent such as water or other suitable solvent. The decontaminants, modifiers (e.g., rheology modifier, pigment, sorbents, etc.), and other additives may be added to complete the dilution to the correct percentage of polymer solids. This may be directly applied. Optionally, actives that require specific chemistry may be added immediately before application.

When used, the composition may be applied as a coating to a surface including a material of interest. The surface may be, for example, a hard, non-porous surface, such as a glass, metal surface (e.g., stainless steel), a painted surface, concrete surface, or other. Other surfaces are contemplated, including, but not limited to, polymeric surfaces (e.g., plastics), flexible surfaces, porous surfaces, fibrous surfaces, and fabric surfaces.

The material of interest may be, for example, a biological agent (naturally or non-naturally occurring organism or component thereof), a chemical nerve agent, a chemical blister agent, a blood agent (i.e, an agent that can exist in blood, replicate in blood, infect a component of blood, alter the function of a component of blood, structurally alter a component of blood), a lung damage agent, toxic industrial chemical, and/or a toxic industrial material.

Illustrative examples of toxic industrial chemicals or toxic industrial material include but are not limited to benzene acrylamide, chlorine, hydrogen chloride, phosgene, aldrin, dieldrin, endrin, lindane, heptachlor, piperonyl butoxide, pentachlorophenol, hexachlorobenzene, calcium cyanide, methyl bromide, phosphine, methylmercury acetate, methylmercury cyanide, petroleum wastes, among others.

A biological agent is optionally a bacteria, a virus, fungi, protozoa, worm, insect, or protein (optionally an infectious protein). Optionally, a biological agent is a bacterial organism. A bacterial organism is optionally one or more of Staphylococcus aureus, Bacillus anthracis, Pseudomonas aeruginosa, Acinetobcter baumannii, Bacillus subtilis, Bacillus globigii, Yersinia pestis, Francisella tularensis, Br. melitensis, Burkholderia pseudomallei, C. botulinum, or Burkholderia mallei. A biological agent is optionally a bacterial spore, optionally a spore of Bacillus anthracis or Bacillus thuringiensis var. Kurstaki.

A biological agent is optionally a virus. Illustrative examples of a virus include but are not limited to human immunodeficiency virus (HIV), norovirus, varicella virus, variola virus, rabies virus, papillomavirus, cytomegalovirus, among others. Other illustrative examples include Filoviridae viruses (e.g. Marburg virus and Ebola virus), Arenaviridae viruses (e.g. Lassa virus and Machupo virus), alphaviruses (e.g. Venezuelan equine encephalitis, eastern equine encephalitis, western equine encephalitis), Nipah virus, Hanta virus, H1N1 or other influenza virus, among others.

When the material of interest is a biological agent, it may be, for example, a category A or a category B biological agent, such as Bacillus anthracis (anthrax), Clostridium botulinum (botulism), Yersinia pestis (plague), Variola major (smallpox) or other pox viruses, Francisella tularensis (tularemia), viral hemorrhagic fever viruses, arenaviruses, bunyaviruses, flaviviruses (including Dengue), filoviruses (including Ebola and Marburg), Burkholderia pseudomallei (melioidosis), Coxiella burnetii (Q fever), Brucella species, ricin, staphylococcus enterotoxin B, bacteria (including E. coli, salmonella, Listeria monocytogenes, Hepatitis A, mosquito-borne encephalitis viruses, and the like. In some embodiments, the material of interest may be a simulant of a biological agent, a chemical nerve agent, a chemical blister agent, a blood agent, a lung damage agent, and/or a toxic industrial chemical. In one particular embodiment, the material of interest may be Bacillus anthracis (B. anthracis) or Bacillus atrophaeus (B. atrophaeus), a simulant of B. anthracis, or a spore thereof

The composition may be applied to the surface as an aqueous (or other liquid) composition using any suitable coating method. For example, the composition may be applied by spraying, rolling, or the like. In some particular embodiments, the composition is applied by spraying the composition onto the surface. As briefly described above, in various embodiments, the composition optionally has a viscosity that enables it to be applied as a coating on a sloped or even vertical or overhead (e.g. hanging) surface such that the composition will sufficiently polymerize or dry so and to continue to coat the surface.

Optionally, the composition is applied to the surface to substantially completely coat the surface, with substantially no holes, gaps, or interruptions in the coating. The composition may be applied at any suitable thickness, although in various embodiments, the composition is applied at a thickness sufficient to produce a polymeric coating having a thickness of from about 100 μm to about 500 μm after curing. Although thinner or thicker coatings may be applied, the coating should be thick enough to exhibit the appropriate properties (including strength and elasticity) to enable it to be completely removable by peeling and optionally completely neutralize the material of interest while being thin enough to not result in wasted material or adversely impact cure time.

After the composition is applied to the surface, the composition encapsulates the material of interest. In particular, it is believed that the composition may create an occlusive seal between the surface and material of interest and the environment, which is effective to encapsulate the material of interest from the environment. For example, an optional active decontaminant in the composition may flow around and coat or otherwise adhere to the particles of the material of interest that are present on the surface. While the material of interest is encapsulated, the active decontaminant works to further neutralize the material of interest. As described in greater detail above, the mechanism of neutralization of the material of interest may vary depending on the particular active decontaminant employed. In embodiments including one or more additives in the composition, it is further contemplated that by-products of the neutralization of the material of interest may further be broken down or otherwise rendered non-toxic by one or more of the additives, optionally as described above.

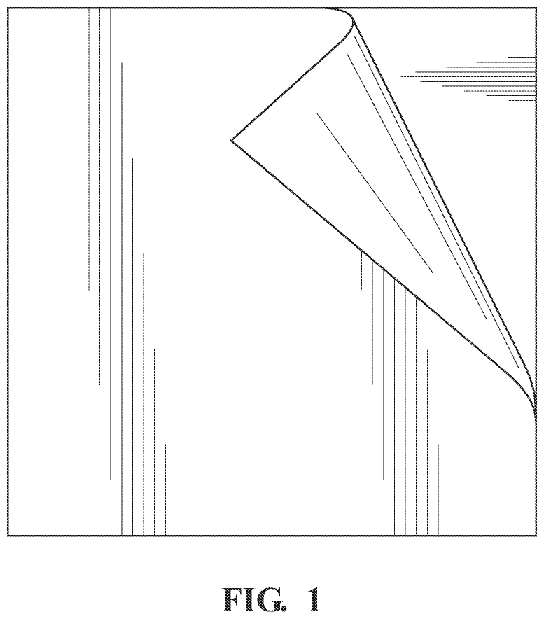

After the material of interest is encapsulated, the composition is cured, thereby forming a polymeric coating on the surface, as shown in FIG. 1. Curing may be conducted at room temperature, or in some embodiments, the coating may be exposed to light and/or heat in order to cure the composition into the polymeric coating. In various embodiments, the composition is cured within a time of about 2 hours or less from the time that the composition is applied as a coating. Longer or shorter cure times are contemplated, depending on the particular film-forming polymer or elastomer that is employed. However, in some embodiments, a cure time of about two hours or less may be desired in order to enable efficient removal of the material of interest from the surface. As the composition cures, the particles of the material of interest adhere to or become entrapped in the polymeric coating.

After the composition has cured into a polymeric coating on the surface, the polymeric coating is optionally peeled from the surface as illustrated in FIG. 1. Removal of the polymeric coating may be performed soon after or immediately after curing is complete, such as when the surface is to be used, or the removal may be conducted some time later. For example, the polymeric coating may be left in place while work is conducted around the surface without concern of cross-contamination by the material of interest. In various embodiments, the polymeric coating may be peeled off in a single piece, or in several large pieces, without flaking. Accordingly, the polymeric coating, along with the material of interest encapsulated therein, may be completely removed from the surface by peeling it from the surface. In embodiments in which the composition includes a pigment, as one example, confirmation that the removal of the polymeric coating is complete may be visual, such as by observing that there is no colored polymer coating remaining on the surface.

After removal from the surface, the polymer coating may be rolled or folded upon itself to keep the material of interest isolated from the environment. In such cases, even if the material of interest has not been completely neutralized by any active decontaminant, the material of interest is prevented from further contaminating the environment or spreading through the environment. Moreover, in the event that the material of interest has not been completely neutralized, neutralization of the material of interest may continue after the polymeric coating is peeled from the surface.

Also provided is a sampling device that employs as a portion of the device or as the device itself, a composition as provided herein. In some embodiments of a sampling device, the composition may be applied to one or more surfaces of the device, or side, of a sheet material. The sheet material may be formed from, for example, a relatively rigid material, optionally a polymerized or otherwise rigid polymer. Illustrative polymers may include polycarbonate, polyvinylidene fluoride (PVdF), polystyrene, acrylic, nylon, polyethylene, polypropylene, polyvinyl chloride, among others. The composition may be formulated as an adhesive composition coated onto a surface of the sheet material.

After application to a sheet material, the composition may dry for immediate or later use. Optionally, to activate a composition when employed in sampling device, the composition may be activated such as by moistening the area with water or other suitable activation agent. For example, sterile water may be applied to the surface using an applicator. Alternatively, a protective strip may be placed over the composition to maintain tackiness of the film on the sheet material. In such embodiments, the protective strip may be removed prior to using the sampling device in order to expose the film formed from the composition.

Once activated, the composition may adhere to or absorb materials of interest in the air or on a surface when the composition is exposed to the material of interest. For example, the sampling device may be applied to the surface with the side including the composition in contact with the surface and the material of interest may adhere to the composition. Alternatively, such as in embodiments in which the material of interest is present as a contaminant in the air, the sampling device may be exposed to the air for time sufficient to enable the material of interest to adhere to the composition.

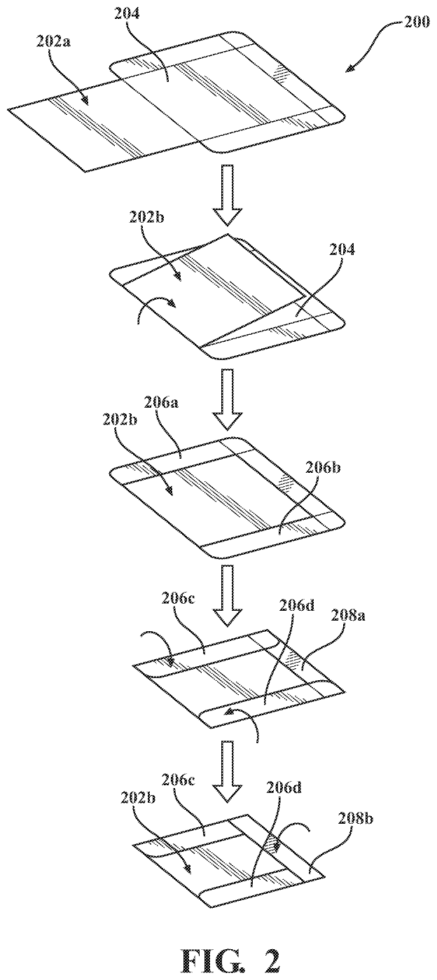

Optionally, a sampling device may be foldable. The sheet material including the composition may be folded upon itself optionally to seal the material of interest inside following exposure of the composition to the material of interest. FIG. 2 schematically depicts a sampling device 200 in accordance with various embodiments in which the device is foldable. In FIG. 2, the composition may be applied as a film to the internal panel 202a of the sheet material. The composition may additionally or alternatively be applied as a film to the internal panel 204 of the sheet material. After exposure to the material of interest, the internal panel 202a may be folded up and into contact with internal panel 204, adhering the internal panels 202a and 204 to one another while exposing panel 202b, which is on the opposing side of the sheet material from the internal panel 202a. Next, the side panels 206a and 206b may be folded in and into contact with the panel 202b. When the side panels 206a and 206b are folded in, side panels 206c and 206d, which are on the opposing side of the sheet material from side panels 206a and 206b respectively, can be seen. Finally, the top panel 208a may be folded down into contact with the panel 202b and side panels 206c and 206d. Thus, as shown in FIG. 2, when folded, the surface including the composition is completely sealed and only the opposing side of the sheet material is exposed to the environment.

The composition may then be sealed into a packaging material, such as an envelope formed from biaxially-oriented polyethylene terephthalate (BOPET; commercially available as MYLAR®) for transportation to a testing or other analysis facility. However, it is contemplated that in some embodiments, testing or at least partial processing of the sampling device may be conducted at the same location as collection.

For analysis, the composition alone or the sampling device as a whole may be dissolved in an organic solvent or aqueous solvent system. In some embodiments, the solvent may be simply water or a water-based solution. For example, the composition or sampling device may be placed in water and dissolved with vortex and/or centrifugation. Other solvents may be used, depending on the particular materials employed for the composition. Filtration, recovery, and other extraction techniques may be employed to retain and/or concentrate the material(s) of interest as analytical samples.

Following obtaining analytical samples of the material of interest, one or more assays may be conducted to identify the material of interest and/or confirm the presence or absence of the material of interest. For example, any one or more known chromatographic techniques, spectroscopic techniques, or other analytical chemistry techniques may be employed, including, but not limited to, gas chromatography (GC), liquid chromatography (LP or HPLC), mass spectrometry, x-tray diffraction, atomic absorption, scanning electron microscopy, or the like. Alternatively or in addition, DNA assays, direct spore counting, or the like may be employed. As a result of the analysis, causes of contamination can be identified, and other decontamination processes may be implemented.

Various aspects of the present disclosure are illustrated by the following non-limiting examples. The examples are for illustrative purposes and are not a limitation on any practice of the present invention. It will be understood that variations and modifications can be made without departing from the spirit and scope of the invention. Reagents illustrated herein are commercially available, and a person of ordinary skill in the art readily understands where such reagents may be obtained.

### EXAMPLES

The ability of a liquid and/or polymeric composition to remove and kill bacterial endospores of Bacillus atrophaeus dried onto glass carriers was ascertained substantially in accord with ASTM method E2414-05 “Standard Test Method for Quantitative Sporicidal Three-Step Method (TSM) to Determine Sporicidal Efficacy of Liquids, Liquid Sprays, and Vapor or Gases on Contaminated Carrier Surfaces” with minor modifications. Testing was performed using 2.5 cm×2.5 cm microscope slide glass as a substrate. A sample preparation tube was a 50 ml conical centrifuge tube instead of a standard 1.5 ml microcentrifuge tube.

Briefly, individual glass coverslips (25 mm×25 mm) are spiked with an aliquot (0.1 ml) Bacillus atrophaeus spore (Raven Biological Laboratories, Inc.) suspension of about 1.7×10¹⁰ spores/ml, spread evenly over the surface and allowed to dry overnight. A 3 mm edge was left un-spiked to ensure the spiked area could be completely covered with the composition under test (i.e. no fugitive spores were contained in the side edge or back of the slide). Prior to inoculation, the glass slides were pre-sterilized and pre-cleaned using ethanol to remove fingerprints or other contaminants and the coupon was allowed to dry.

A series of compositions are formed using the vinyl resin sold as FLOORPEEL™ 4000 (General Chemical Corporation (Brighton, MI) (20 wt % in water) spiked with various amounts of the active decontaminant tetrakishydroxymethyl phosphonium sulfate (THPS), triclosan, or benzalkonium chloride (BAC) in various combinations with the final amounts of active decontaminant being 1 wt %, 2 wt % or 4 wt %. The final pH of the composition is adjusted to about 8.3 using Na₂CO₃. Formulations of compositions are tested within one hour of formation.

Small glass carriers were coated onto the glass substrates using a disposable coating apparatus comprising a steel base to which two glass sheets were glued on either side of the glass carrier. The carrier to be coated was placed in a channel created by the set of neighboring plates to create a single level plane. To coat the carrier, the drawdown bar was dragged across the composite glass surface and then the coated glass carrier was removed and allowed to dry. For these coatings a drawdown bar with a 12 mil gap was used resulting in a dry thickness of approximately 6 mils. The polymer emulsions were allowed to dry for 120 minutes.

After 120 min of contact time, each of the dried compositions were peeled off the glass substrates with sterile forceps and any remaining spores on the glass were assayed for both number and cultivability. The test substrates are placed in individual 50 ml conical tubes (1 per tube) and sufficient volume of cold growth media (i.e., 20 ml) is added to completely cover the material. The tubes were then sonicated for 10 min and vortexed for 2 minutes. Alternatively, the spores were scraped from the surface of the glass substrates using a policeman. Spores recovered following removal were counted directly by phase contrast microscopy using a Petroff-Hausser counting chamber and then plated onto TSA plates over a series of 10-fold serial dilutions to determine the number of cultivable spores as colony forming units (CFU) by outgrowth. Plates are incubated for 24 hours at 37° C., the number of colonies counted, and the plates incubated and recounted at 48 hours. The colony counts were converted to log₁₀ and reductions are reported as both log reduction and percent kill. Results are illustrated in Table 1.

TABLE 1

| | 1 wt % | 2 wt % | 4 wt % |
|---|---|---|---|
| Formulation | biocide | biocide | biocide |
| Initial spore “seeding” (CFU) | 1.7 × 10⁹ | 1.7 × 10⁹ | 1.7 × 10⁹ |
| Post-treatment recovery (CFU) | 2.53 × 10⁷ | <133 | <133 |
| Live spore reduction (CFU) | 6.71 × 10¹ | >1.28 × 10⁷ | >1.28 × 10⁷ |
| log₁₀ reduction | 1.83 | >7.11 | >7.11 |

As a negative control, a composition without any active decontaminant included was also tested. Results showed that greater than 93% of the seeded spores were removed by adhering to or being embedded into the cured composition. The presence of the biocide in a composition, particularly at 2 wt % and 4 wt % dramatically reduced the viability of any spores remaining on the glass slides such that substantially no spore growth was found in these samples following peeling of the composition.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of collecting a material of interest for detection, comprising:
contacting a liquid polymeric coating to a substrate surface or gas, said substrate or gas comprising the material of interest, the polymeric coating comprising a polymer or polymerizable resin;
encapsulating the material of interest with the polymeric coating;
curing the liquid polymeric coating to form a sampling device, and
peeling the sampling device from the surface so as to remove the material of interest from the surface.

2. The method of claim 1, wherein the material of interest is selected from the group consisting of a biological agent, a chemical nerve agent, a chemical blister agent, a radiological agent, a blood agent, a lung damaging agent, a toxic industrial chemical (TIC), a toxic industrial material (TIM), any other agent used in a weapon of mass destruction, and any combination thereof.

3. The method of claim 2, wherein the material of interest is a biological agent comprising a bacteria, a bacterial spore, a protein, or a virus.

4. The method of claim 1, wherein polymeric coating comprises a pH modifier, pigment, suspension aid, rheology modifier, solid sorbent, ion exchange resin, or combination thereof.

5. The method of claim 1, wherein the surface comprises a painted surface, a plastic surface, or a glass surface.

6. The method of claim 1, wherein said polymeric coating is cured onto said surface within a time of 2 hours or less at room temperature.

7. The method of claim 1, wherein said sampling device is peeled from said surface in a single piece, or in several large pieces, without flaking.

8. The method of claim 1, wherein said polymeric coating is applied to said substrate using a sheet material.

9. The method of claim 8, wherein said polymeric coating is present on one side of the sheet material.

10. The method of claim 8, wherein said sheet material is formed from one or more polymers selected from the group consisting of polycarbonate, polyvinylidene fluoride (PVdF), polystyrene, acrylic, nylon, polyethylene, polypropylene, polyvinyl chloride, and combinations thereof.

11. The method of claim 1, further comprising rolling or folding said sampling device upon itself to seal the material of interest inside a folded sampling device following said peeling.

12. The method of claim 1, further comprising dissolving said sampling device or a portion thereof in an organic or aqueous solvent to form a dissolved sampling device.

13. The method of claim 12, further comprising extracting said material of interest from sampling device by applying filtration, recovery, or other extraction technique to said dissolved sampling device.

14. The method of claim 1, further comprising analyzing said sampling device by one or more chromatographic techniques, spectroscopic techniques, or other analytical chemistry technique.

15. The method of claim 14, wherein said technique is selected from the group consisting of gas chromatography, liquid chromatography, mass spectrometry, x-ray diffraction, atomic absorption, scanning electron microscopy, DNA assay, and direct spore counting.

16. A sampling device comprising:
a sheet material;
a liquid polymeric coating contacting at least a portion of the sheet material, the polymeric coating comprising a polymer or polymerizable resin;
wherein said polymeric coating is curable as a film on or in the sheet material so as to form a sampling device configured to adhere to a surface so as to be peeled from the surface in a single piece, or in several large pieces, without flaking.

17. The sampling device of claim 16, further comprising a removable protective strip applied to said polymeric coating.

18. The sampling device of claim 16, wherein said sheet material is formed from one or more selected from the group consisting of polycarbonate, polyvinylidene fluoride (PVdF), polystyrene, acrylic, nylon, polyethylene, polypropylene, polyvinyl chloride, and combinations thereof.

19. The sampling device of claim 16, further comprising a packaging material configured to encapsulate the sampling device.

20. The sampling device of claim 19, wherein said packaging material is formed from a biaxially-oriented polyethylene terephthalate.

21. The sampling device of claim 16, further comprising at least one of a pigment, a suspension aid, or a rheology modifier.
